(19) United States
(12) Patent Application Publication
(10) Pub. No.: US 2002/0121286 A1
(43) Pub. Date: Sep. 5, 2002

(54) Rinsing solution and rinsing and drying methods for the prevention of watermark formation on a surface

(75) Inventors: Steven Verhaverbeke, San Francisco, CA (US); J.Kelly Truman, Morgan Hill, CA (US)

Correspondence Address: Patent Counsel, MS/2061, Legal Affairs Dept., Applied Materials, Inc., 3050 Bowers Avenue, Santa Clara, CA, 95054, US

(73) Assignee: Applied Materials, Inc.

(21) Appl. No.: 09/755,720

(22) Filed: Jan. 4, 2001

(51) Int. Cl. B08B 3/02

(52) U.S. Cl. 134/1.3; 134/3; 134/33; 134/36; 134/30

(57) ABSTRACT

The present invention is a novel rinsing solution and a novel rinsing method for use in a single wafer cleaning process. According to the present invention the cleaning solution comprises water, an acid, and hydrogen gas. In an embodiment of the present invention the rinsing step would also comprise the filtering of ammonia (NH₃) from the air around the cleaning station. In another embodiment of the present invention the rinsing step would be followed by a drying step that uses velocities of air exceeding 0.1 m/s.

### BACKGROUND OF THE INVENTION

1. Field of the Invention

The present invention relates to the field of semiconductor processing and more specifically the rinsing and drying of a semiconductor wafer substrate, particularly as applied in a single wafer cleaning process.

2. Discussion of Related Art

In semiconductor manufacturing the rinsing and drying of semiconductor wafers are critical steps in the front end of the line processing of wafers. This is because during the front end of the line processing of wafers the active regions of the device can be exposed to contamination. The risk of contamination does not exist in the later processing because the active regions of the device are sealed and only interconnections are exposed. In the front end of the line processing of wafers, the rinsing and drying of semiconductor substrates (wafers) as the last step after a series of steps in an aqueous cleaning procedure are the most critical steps in maintaining and enhancing the purity of the pure elemental surface of the substrate. Pure elemental surfaces are highly reactive because of their highly energetic surface states. These surfaces are therefore likely to be either oxidized or contaminated. The degradation of device performance and the decrease of device yield results from the oxidation and contamination of these surfaces of semiconductor wafers.

In the current state of the art, the last step in an aqueous cleaning procedure is usually a rinsing with ultra-pure water followed by a drying step. The active regions of the substrate are likely to react with the rinse water and become oxidized by oxygen and hydroxide ions in the water or to become contaminated by impurities in the water. Also, the drying step must be efficient to reduce the possibility of exposure of the substrate to impurities

In wafer processing there are a large number of different materials that can be in contact with cleaning liquids. Surfaces encountered in semiconductor manufacturing include: silicon surfaces (both monocrystalline and polycrystalline silicon), dielectric films (such as silicon oxide, silicon nitride, and silicon oxynitride), metallic films (such as Al, Ti, TiW, Cu, TiN, TA, and TaN), and photoresists and low dielectric constant insulators made of polymers. Reactions between the rinse and most of these surfaces are not a problem. For example, the polymers in the early processing of wafers are usually limited to photoresist layers and are usually completely removed from the surface of the wafer before rinsing and drying, except in some specific applications. The dielectric films in the early processing of wafers, such as silicon oxide, silicon nitride, silicon oxyniride, doped silicon oxides (e.g. BPSG), and spin-on oxides, are almost completely oxidized and are virtually inert to the rinsing water and drying gases.

Pure silicon surfaces, on the other hand, are particularly prone to oxidation and to reacting with contaminants during the rinse and dry. When exposed to rinsing water, silicon surfaces can react with the water to form solid, adhered, or dissolved silica (HSiO₃—). The dissolved silica can then deposit back onto the surface during drying to form a watermark. Watermarks are problematic because they can interfere with etching of the substrate by physically blocking the etching of the substrate. They are also electrically problematic because they can serve as an insulator in an area where optimal conductivity is desired.

Traditionally, the reduction of ionic silica (HSiO₃—) formation is avoided by reducing the contact time of the silicon surface with the rinse water, by reducing the oxygen content of the rinse water, and by keeping the temperature of the rinse water low. This method works well when the wafers are immersed in a bath because the water in a bath is only exposed to the atmosphere at its surface. This limited exposure to the atmosphere minimizes oxygen uptake by the rinse water, which in turn decreases the possibility that the rinse will oxidize the silicon surface. Single wafer cleaning tools that either spray or dispense rinse water onto a wafer that is spinning on its horizontal surface have also been used. With the use of single wafer cleaning tools the problem of oxygen uptake by the rinse water becomes excessive because a large surface area of the water is exposed to the atmosphere.

One method that has been developed to address this problem is to put the spinning wafer between two plates and to run nitrogen gas in between those two plates to reduce the amount of oxygen in the atmosphere around the wafer. This method is problematic because droplets of the rinse water adhere to the horizontal plates that are on each side of the wafer and can pick up contaminants from those plates. In turn, those droplets can transfer contaminants from the plates to the surface of the wafer. Therefore the desired purity and efficiency of the clean cannot be achieved. This method is also expensive.

No other methods have been developed to minimize ionic silica formation in a horizontal single wafer spinning cleaning tool, but other methods addressing this problem have been proposed for wet benches (i.e. in tools where the wafers are immersed in a rinse bath). In one proposal, the pH of the rinse water is lowered in order to reduce particulate contamination. According to this proposal, the lowered pH of the rinse when used in an immersion bath in combination with megasonic irradiation optimizes particle removal from the surface of the wafers. The low pH is used to shield the forces that attract the suspended particles to the silicon surface. Megasonic irradiation is used to overcome attraction forces between the suspended particles and the silicon surface. Another approach used by wet benches is to dissolve hydrogen gas into the rinse. A hydrogenated rinse combined with megasonic irradiation suppresses native oxide growth, and increases the H-termination of the silicon surface.

Thus, what is desired is a method of minimizing silica ion formation during the final rinse and drying steps in the front end of the line processing of wafers, primarily when using a horizontal spinning wafer cleaning tool. The prevention of watermarks is the main concern. The present invention provides a method for use in a horizontal spinning wafer cleaning tool that will allow for the desired purity of pure silicon surfaces.

### SUMMARY OF THE INVENTION

The present invention is a method of use of a novel aqueous rinsing solution and the drying process subsequent to the rinse. According to the present invention the method involves using a rinsing solution in a single wafer mode and the rinsing solution comprises at least water, hydrogen gas, and an acid. In an embodiment of the present invention the rinsing step would also comprise the filtering of ammonia (NH₃) from the air around the cleaning station. In another embodiment of the present invention the rinsing step would be followed by a drying step that uses velocities of air exceeding 0.1 m/s. The same rinsing solution containing water, hydrogen gas, and an acid may also be used in a multiple wafer mode for certain applications.

### BRIEF DESCRIPTION OF THE DRAWINGS

FIG. 1 is a flowchart illustrating the relevant steps in the early processing of wafers to the present invention.

FIG. 2a is an illustration of a cross-sectional view of a patterned surface after the typical cleaning steps in the early processing of wafers.

FIG. 2b is an illustration of a cross-sectional view of a patterned surface after an HF step.

FIG. 2c is an illustration of a cross-sectional view of a patterned surface after a rinsing step and during a drying step.

FIG. 3a is an illustration of a cross-sectional view of a single wafer cleaning apparatus.

FIG. 3b is an illustration of a cross-sectional view of a venturi apparatus.

FIG. 4 is an illustration of a cross-sectional view of a hydrophobic membrane apparatus.

FIG. 5 is an illustration of a cross-sectional view of a typical clean room used for the cleaning steps in the early processing of wafers.

FIG. 6 is an illustration of a cross-sectional view of a single wafer cleaning chamber.

### DETAILED DESCRIPTION OF THE PRESENT INVENTION

In the following description numerous specific details are set forth in order to provide a thorough understanding of the present invention. One of ordinary skill in the art will understand that these specific details are for illustrative purposes only and are not intended to limit the scope of the present invention. Additionally, in other instances, well-known processing techniques and equipment have not been set forth in particular detail in order to not unnecessarily obscure the present invention.

The present invention is a rinsing solution for a wafer and methods of rinsing and drying a wafer in a single wafer mode that will prevent the formation of watermarks on pure silicon surfaces. Watermarks are created by the deposition of ionic silica (HSiO₃—) onto pure silicon surfaces. Silica is formed by the reaction of hydroxide ions and oxygen molecules in an aqueous rinse with the pure silicon surface. This reaction is time and temperature dependent. The present invention serves to prevent watermarks by preventing this reaction that forms ionic silica. Ionic silica is formed according to the following formula:

Si+O₂+OH—→HSiO₃—

The formation of HSiO₃— in this reaction is dependent on four variables: (1) hydroxide ion concentration, (2) dissolved oxygen concentration, (3) contact time, and (4) temperature. The present invention prevents this reaction by minimizing all or some of these variables on which the reaction is dependent. The hydroxide ion concentration of the rinse solution is minimized by adding an acid to the rinse water. Another way that the hydroxide ion concentration is minimized is by filtering ammonia gas vapors (NH₃) from the air around the cleaning station so that ammonium hydroxide (NH₄OH) cannot form in the rinse water and increase the hydroxide concentration in the rinse water. The concentration of dissolved oxygen in the rinse solution is minimized by dissolving hydrogen gas into the rinse solution. The contact time is minimized by reducing the time that the hydroxide in the rinse is in contact with the pure silicon surface. This is done preferably by drying the rinse water using large velocities of air in excess of 0.1 m/s. This may also be done by quickly spin drying the horizontally positioned wafer around its own axis at high rotation speeds. Additionally this can be done by blowing isopropyl alcohol (IPA) vapor on the wafer surface during spin drying the wafer. The temperature is preferably minimized by using rinse water at room temperature or at temperatures lower than room temperature.

According to the preferred embodiment of the present invention, a rinsing solution for use in a single wafer spinning cleaning tool is disclosed in which the hydroxide ion concentration, the dissolved oxygen concentration, and the contact time is minimized in order to prevent the formation of watermarks on pure silicon surfaces. The rinsing solution of the present invention consists of water (H₂O), hydrogen gas (H₂), and an acid. This composition serves to decrease ionic silica formation (watermarks) on pure silicon surfaces because of the minimized hydroxide ion and oxygen molecule concentrations of the rinse. The hydroxide ion concentration of the rinse water is minimized by the presence of the acid and the dissolved oxygen concentration is minimized by presence of the hydrogen gas. In alternate embodiments of the present invention the rinse solution used in a single wafer cleaning tool may be comprised of only water and an acid to take advantage of the minimization of hydroxide ions, or only water and hydrogen gas to take advantage of the minimization of dissolved oxygen. The rinse solution comprising water, an acid, and hydrogen gas is preferred because it would provide the most effective environment for the prevention of ionic silica formation.

Acids that are suitable for use in the rinse solution are HCl, HNO₃, H₂SO₄, HF, acetic acid, citric acid, and CO₂. Both liquid acids and gaseous acids may be added to the rinse solution. In one embodiment, carbonic acid (H₂CO₃) is formed in the rinse by the addition of CO₂ to the rinse. Carbon dioxide is inexpensive and it also does not require additional steps in preparation as a liquid acid would. According to another embodiment of the present invention the rinsing solution has a pH between 1.0 and 6.5 and more specifically between 3.0 and 6.0. Also, according to yet another embodiment of the present invention the hydrogen gas concentration in said rinse is between 0.01 mg/l and 5 mg/l.

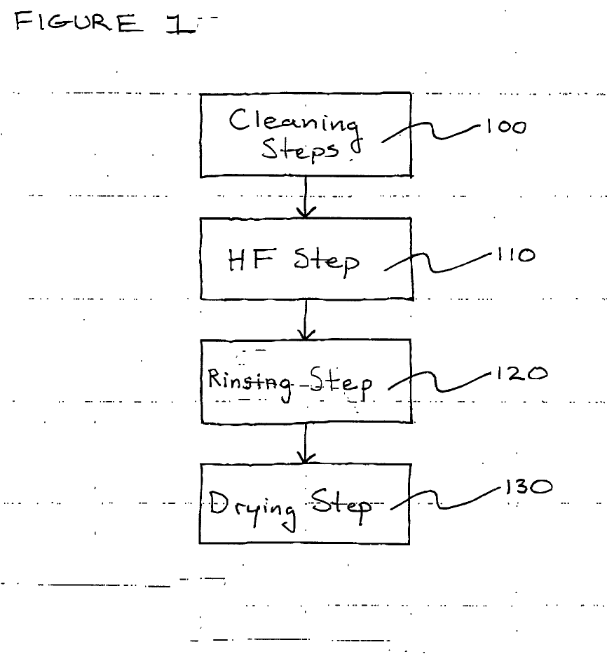

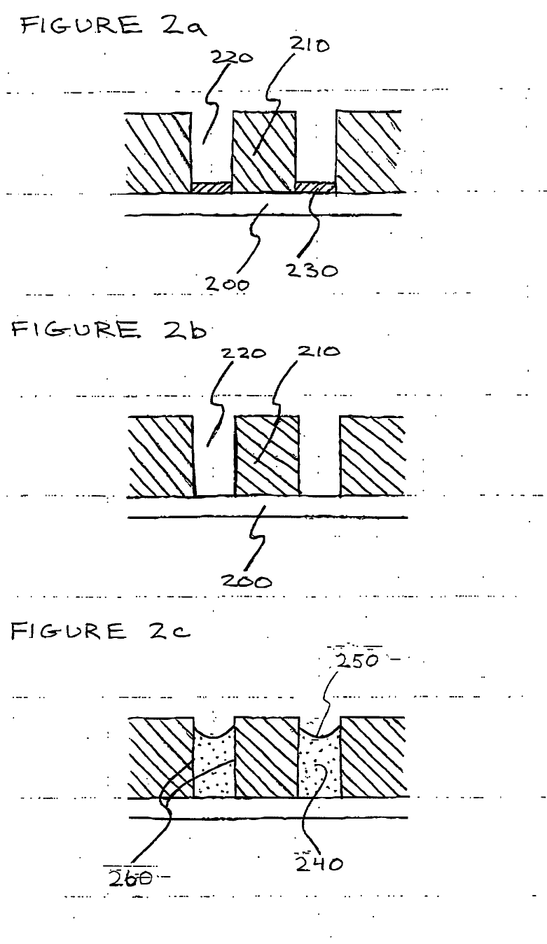

The rinsing solution is meant for use on pure silicon surfaces that are exposed during the front end of the line processing of wafers. Generally, pure silicon surfaces are only exposed after a hydrogen fluoride (HF) cleaning or etching step. FIG. 1 shows the relevant processing steps in the early processing of wafers. During the cleaning steps 100 exposed pure silicon surfaces of wafers will be oxidized by the typical aqueous cleaning solutions that are used. The typical cleaning solutions are standard clean 1 (SC1) and standard clean 2 (SC2). SC1 consists of a mixture of NH₄OH, H₂O₂, and H₂O. SC2 consists of a mixture of HCl, H₂O₂, and H₂O. The hydrogen peroxide in these cleaning solutions will oxidize any exposed pure silicon surfaces such as the pure silicon substrate at the bottom of trenches and contacts that have been patterned onto a wafer. FIG. 2a shows an example of this oxidation layer 230 at the bottom of trenches 220 that have been etched into a dielectric layer 210 that overlies a silicon substrate 200. The HF step 110 that usually follows the cleaning steps 100 will remove this oxidation layer on the silicon as shown in the example in FIG. 2b. Alternatively the HF step may be used by itself without the prior cleaning steps. The rinsing step 120 will come after the HF step 110 that will reveal a pure silicon surface such as the silicon substrate 200 in FIG. 2b. A drying step 130 will follow the rinsing step 120. The rinsing step 120 and the drying step 130 are the most relevant steps in the minimization of the exposure of the pure silicon surface to hydroxide ions and oxygen in the rinse water in the present invention.

There are two situations during the rinsing and drying of wafers where the formation of watermarks or silica on pure silicon surfaces is most problematic and the rinse solution will be of most use. The first situation is when any pure silicon surface is exposed to an aqueous rinse during the rinsing step 120 because of the potential for the reaction of the rinse water with the pure silicon surface. The second situation is when pure silicon is exposed within the trenches or contacts of a patterned surface. The second situation is especially problematic because the risk of watermark formation extends beyond the duration of the actual rinsing step 120 into the drying step 130.

Watermarks made out of deposited silica may form in the trenches and contacts during the drying step 120 because the rinse water will remain within the trenches and contacts due to the strong adhesive force of the capillary pressure. The longer the rinse water remains in the trenches and contacts, the longer any pure silicon surfaces that may be at the bottom of the trenches or contacts will be exposed to the rinse water. The retention of the rinse water within the trenches and contacts of a typical patterned surface is depicted in FIG. 2c. FIG. 2 shows a pure silicon substrate 200 on which a dielectric layer 210 (e.g. SiO₂) has been deposited. The dielectric layer has been etched to form trenches 220. The walls of the trenches 260 will act as capillary tubes and retain the rinse water 240. In the example of FIG. 2, the hydroxide ions and the dissolved oxygen in the rinse water that is retained within the trenches 220 may react with the pure silicon substrate 200 at the bottom of the trenches.

The rinse water will be retained within the trenches because silicon, as well as the materials that are typically used as the dielectric insulating materials (e.g. silicon dioxide, silicon nitride), have a contact angle with water of less than 90 degrees, as shown in Table 1 below, that will create a force of adhesion (capillary pressure) between the rinse water and the walls 260 of the trench. Table 1 also shows the range of capillary pressures that are created by the materials that will typically form the walls of trenches in the front end of the line processing of wafers.

TABLE 1
The Capillary Pressures in bars of typical materials during typical
steps in the early processing of wafers

| | Liquid Surface | Contact | Capillary | Water |
|---|---|---|---|---|
| Solid | Tension | Angle | Pressure | column |
| Surface | (dynes/cm) | (°) | (bar) | Height (μ) |
| SiO2 | 72 | 53 | 1.72 | 17.7 |
| Hydrated | 72 | 17 | 2.76 | 28.0 |
| SiO2 | | | | |
| SiO2 after | 72 | 0 | 2.90 | 29.3 |
| SC1 | | | | |
| Si3N4 after | 72 | 30 | 2.48 | 25.3 |
| sulfuric acid | | | | |
| and hydrogen | | | | |
| peroxide | | | | |
| Si3N4 after | 72 | 0 | 2.90 | 29.3 |
| HF | | | | |
| Glass | 72 | 2 | 2.90 | 29.3 |

The occurrence of a curved surface (meniscus) by the liquid (see meniscus 250 in FIG. 2c) leads to a pressure difference across the top surface of the liquid in a trench. The water column height indicates, in the above table, the height of the trench where the liquid will remain when the wafer is held upside down until the weight of the liquid column just balances the pressure difference across the meniscus that is formed at the top of the liquid column. The capillary pressures are greater than 1.72 bar, the highest being 2.90 bar. The capillary pressure is the pressure at the bottom of a trench. The capillary pressure represents a strong force with which the rinse water is held within the trenches. This strong force can hold the rinse water within the trenches for a significant amount of time, allowing for the formation of watermarks. The formation of silica watermarks on pure silicon can be countered by the use of the rinse solution and the rinsing and drying methods taught in this invention.

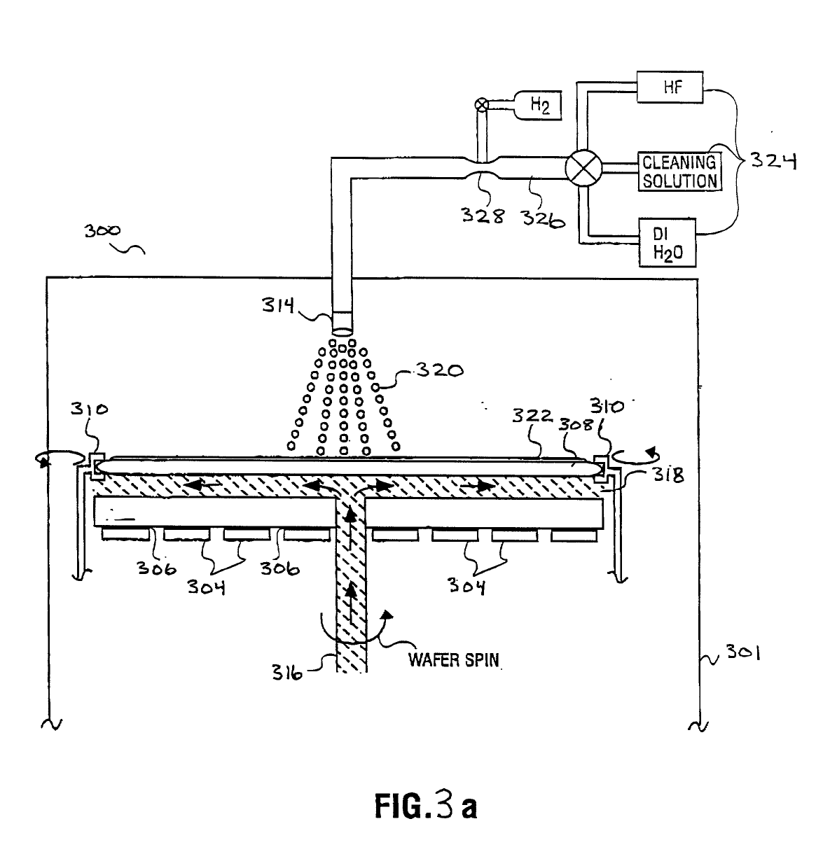

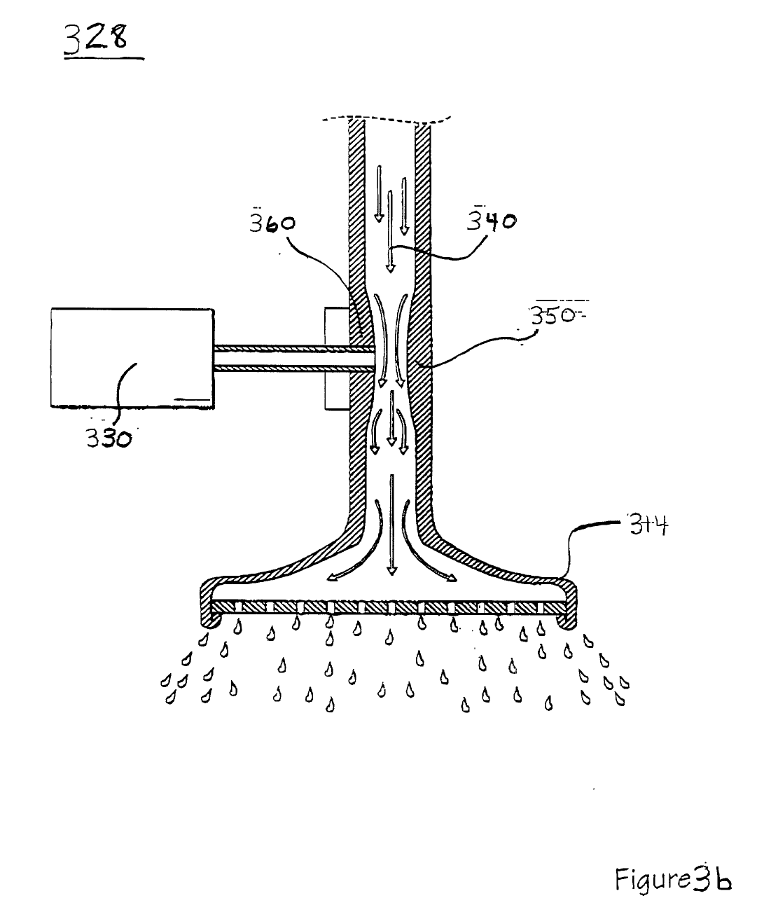

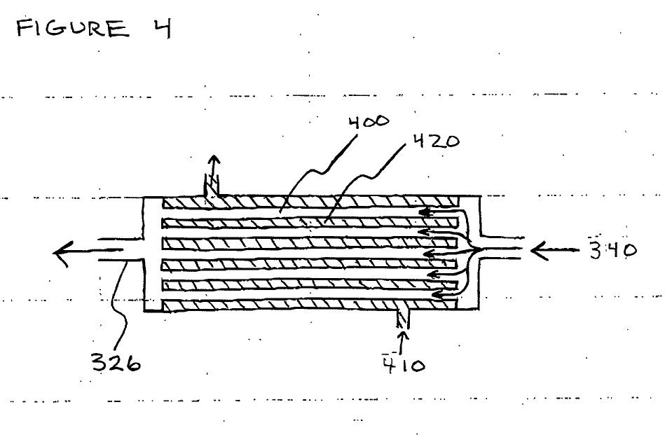

In an embodiment, the rinsing solution and rinsing methods of the present invention are ideal for use with a single wafer cleaning apparatus that utilizes acoustic or sonic waves to enhance a cleaning, such as the apparatus 300 as shown in FIG. 3a. This single wafer cleaning apparatus utilizes acoustic or sonic waves to enhance a cleaning in the cleaning steps 100 of FIG. 1. The single wafer cleaning apparatus 300 shown in FIG. 3a includes a plate 302 with a plurality of acoustic or sonic transducers 304 located thereon. The transducers 304 preferably generate sonic waves in the frequency range between 400 kHz and 8 MHz.

The wafer 308 is clamped by a plurality of clamps 310 face up to a wafer support 312 that can rotate wafer 308 about its central axis. The wafer support can rotate or spin the wafer 308 about its central axis at a rate between 0-6000 rpm. In apparatus 300 only wafer support 312 and wafer 308 are rotated during use whereas plate 302 remains in a fixed position. Additionally, in apparatus 300, wafer 308 is placed face up wherein the side of the wafer with patterns or features, such as transistors, faces towards a nozzle 314 for spraying cleaning solutions or rinses thereon and the backside of the wafer faces plate 308. Apparatus 300 can include a sealable chamber 301 in which nozzle 314, wafer 308, and plate 302 are located as shown in FIG. 3a.

The rinsing solution would be fed through nozzle 314 to generate a spray 320 of droplets that form a liquid coating 322 on the top surface of wafer 308 while wafer 308 is spun. The liquid coating 322 can be as thin as 100 micron. Alternatively a solid flow dispense may be used instead of a spray. Tanks 324 would contain the rinsing solution and the liquid acid as well as other solutions for the cleaning steps prior to the rinsing step. Tanks 324 are coupled to conduit 326 that feeds nozzle 314. The single wafer cleaning apparatus may have a diameter with a conduit 326 that has a reduced cross-sectional area or a “venturi” apparatus 328 in a line before spray nozzle 314 at which point liquids such as acids or gases such as H₂ or CO₂ are dissolved in the rinsing solution as it travels to nozzle 314.

The venturi apparatus is shown in more detail in FIG. 3b. The venturi apparatus 328 enables a liquid or gas to be dissolved into a fluid flow at a gas pressure less than the pressure of the rinse flowing through conduit 326. The venturi will inject liquid or gas 330 into the rinse stream 340 before it passes out the nozzle 314. With this approach, the rinse stream 340 flows past a throat 350 that increases the flow rate thereby reducing the rinse pressure. A small hole (injector port) 360 is placed in the throat 350 that is attached to the liquid or gas source 330. As the rinse stream 340 passes by the liquid/gas injector port 360, the gas 330 is drawn into the lower pressure of the fluid stream 340.

A venturi apparatus may be used in the present invention as a method of adding a liquid or gaseous acid to the rinse water or of adding hydrogen gas to the rinse water. The rinse solution may also be acidified by acidifying the rinse before it is placed into a tank 324, or the acid may be held separately in another tank 324 and then mixed with the rinse water in the conduit 326.

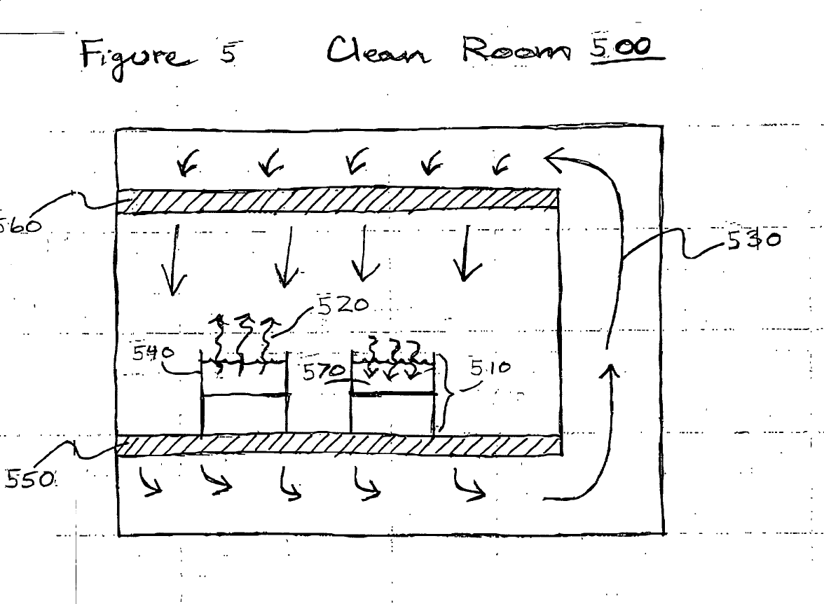

Gases may also be added to the rinse solution as shown in FIG. 4 by passing the rinse flow 340 (FIG. 3) along a hydrophobic membrane 400 that will allow the gas flow 410 to pass into the membranes from the chamber containing the gas 420 into the rinse water. The hydrophobic membrane will not allow the aqueous rinse to pass through in the opposite direction into the chamber containing the gas. One side of the membranes would be exposed to the desired gas. The ideal material that the membrane tubes would be made of is Gore-Tex or another Teflon like material with small pores. If the membrane is used for hydrogen gas only then another material such as polypropylene or polyethylene may be used as well. This membrane apparatus would be placed in line with conduit 326 (FIG. 3) of the single wafer cleaning apparatus.

In the preferred embodiment, a gaseous acid (e.g. CO₂) would be added to the rinse using the hydrophobic membrane method described above. The addition of a gaseous acid using a hydrophobic membrane also ensures complete dissolution of the gas into the aqueous rinse. When gases are added to an aqueous rinse via a venturi apparatus, there is a likelihood that undissolved bubbles of gas will be inserted into the rinse causing the uneven application of the rinse water to the wafer in a singe wafer process. Also, undissolved bubbles of gas also create a danger resulting from the evaporation of the gas from the rinse water into the cleaning chamber. The build-up of certain gases can be explosive. For these reasons, the use of a venturi apparatus works well for the addition of liquids to the rinse, but is not the preferred method for the addition of gases to the rinse.

The rinsing solution of the present invention would be sprayed by nozzle 314 onto the top surface of wafer 308 for approximately 20 seconds while wafer 308 is rotated at a rate between 10-60 rpms to form a thin coating 322 of rinsing solution over the frontside of wafer 308. It is to be appreciated that although the rinsing process of the present invention is ideally carried out in an apparatus 300 as shown in FIG. 3a the rinsing process of the present invention can utilize other apparatuses that are used for cleaning and rinsing a wafer. For example, the megasonic irradiation need not necessarily be used in the cleaning steps 100 of FIG. 1. In fact, no megasonic irradiation may be applied at all. Similarly, the rinsing solution of the present invention need not necessarily be sprayed onto the top surface of the wafer but can also be dispensed onto the wafer by a constant stream of liquid. Additionally, it is important to note that the rinse solution may be used in batch type processing of the wafers where baths are employed.

In another embodiment of the present invention, silica watermarks are countered by filtering NH₃ from the air around the cleaning station. This will help minimize the hydroxide ion concentration of the rinse. It will also prevent the absorption of NH₃ by the rinse, thereby preventing the formation of ammonium hydroxide (NH₄OH) in the rinse water. Preventing the formation of NH₄OH in the rinse water eliminates a source of hydroxide that could add to the hydroxide ion concentration of the rinse. In this embodiment the rinse solution need not necessarily comprise at least water, an acid, and hydrogen gas. The rinse solution may be water and an acid or water and hydrogen gas.

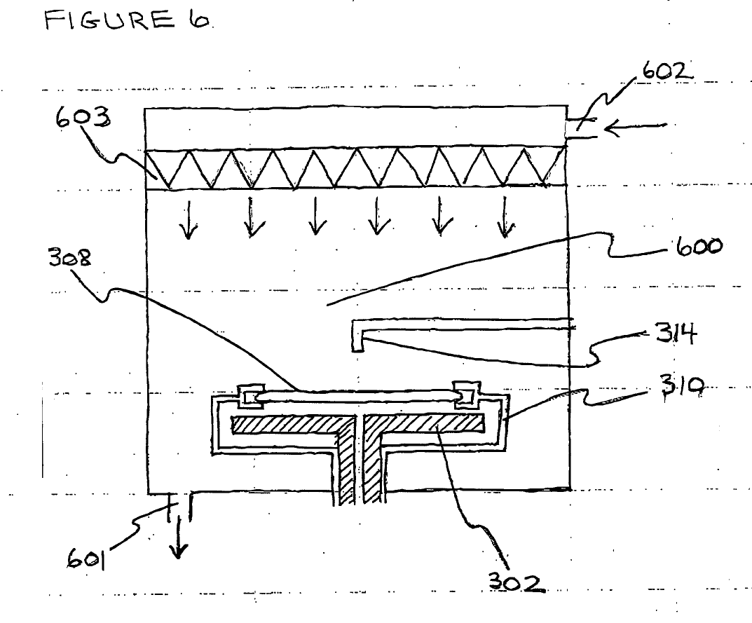

The cleaning station may be a bath for the batch processing of wafers in a clean room. Ammonia gas could be filtered from the recirculating air 530 of a clean room 500, in FIG. 5, from around the cleaning station 510. Ammonia gas vapors may be released into the air by the open baths 540 that are used for a prior cleaning step in the cleaning process. Specifically, a cleaning step that is likely to release ammonia gas vapors is the standard clean 1 (SC1 solution) that is typically used in wafer processing. Standard clean 1 consists of a mixture of NH₄OH, H₂O_{2, and H}₂O. The NH₃ vapors would come from the NH₄OH in the standard clean 1 solution.

The concentration of NH₃ in the air around the cleaning station will increase over time because the air of the clean room recirculates. Once the NH₃ vapors are put into the air around the cleaning station they will continue to recirculate with the air through the floor vents 550 and then back into the air around the cleaning station through the ceiling vents 560. Ammonia gas vapors can continue to be absorbed by the water in the rinse in bath 570 and create an alkaline environment by forming a basic solution of ammonia hydroxide. The filtering of NH₃ from the air around the cleaning station can be accomplished by installing a NH₃ filter on top of the filter-fan unit either in ceiling vents 560 or floor vents 550.

The cleaning station may alternatively be the micro-environment 600 of a single wafer clean chamber as shown in FIG. 6. FIG. 6 shows a detail of the single wafer cleaning chamber that corresponds to the sealable chamber 301 of FIG. 3a in which nozzle 314, wafer 308, clamps 310, and plate 302 are located as shown in FIG. 6. Ammonia gas vapors will be released into the chamber by the use of the standard clean 1 (SC1) solution that will typically be used to clean wafers in this chamber. The ammonia gas will build up within the cleaning chamber itself, but also within the clean room in which the single wafer cleaning apparatus would be placed. Similar to the scenario described above in FIG. 5 for a clean room, ammonia gas will build up within the clean room due to the recirculation of air into which the vapors from the air outlet 601 of the single wafer cleaning chamber are released. The cleaning chamber will continue to take in clean room air with increasing ammonia concentrations from the air inlet 602. When this single wafer cleaning apparatus is used within such a clean room, where the air is recirculated, NH₃ filters may be placed not only on the vents of the clean room, but also over the HEPA filter 603 within the single wafer cleaning chamber.

In another embodiment of the of the present invention, watermarks are countered by the use of large volumes of air with velocities in excess of 0.1 m/s to dry the wafers during the drying step 120 that follows the rinsing step 110 (FIG. 1). The use of large volumes of air with velocities in excess of 0.1 minimizes the drying time of the rinse. This in turn prevents silica formation and watermarks by reducing the time that the hydroxide in the rinse is in contact with the pure silicon surface. In this embodiment the rinse solution need not necessarily comprise at least water, an acid, and hydrogen gas. The rinse solution may be water and an acid or water and hydrogen gas.

This drying method is especially good for the evaporation of the rinse solution that remains trapped within the trenches during the drying step 120 (FIG. 1) due to capillary action. By drying with large volumes of air with velocities in excess of 0.1 m/s the rinse water will remain within the trenches for a shorter period of time. This will limit the amount of time that the hydroxide ions and the dissolved oxygen in the rinse water come in contact with the silicon surface, thereby making it less likely that silica watermarks may form. In a preferred embodiment, a single wafer cleaning apparatus is used that will spin the wafer at high rotation rates to reduce the drying time. In another embodiment isopropyl alcohol (IPA) vapor is blown on top of the spinning wafer during drying to further reduce the drying time. Isopropyl alcohol assists in the drying by lowering the surface tension of the rinse solution on the wafer so that the rinse will spin off of the wafer more easily.

It is to be appreciated that the disclosed specific embodiments of the present invention are only illustrative of the present invention and one of ordinary skill in the art will appreciate the ability to substitute features or to eliminate disclosed features. As such, the scope of the applicant's rinsing solution and rinsing and drying methodologies are to be measured by the appended claims that follow.

Thus, a novel rinsing method and rinsing solution for use in a single wafer cleaning process have been described.

We claim:

1. A method of rinsing a wafer comprising:
providing a wafer; and,
rinsing said wafer with a solution comprising:
H₂O;
H₂ gas; and
an acid.

2. The method of claim 1 wherein said rinsing is done to a single wafer in a single wafer cleaning tool.

3. The method of claim 1 wherein said rinsing is done by spraying said rinse solution on a spinning wafer.

4. The method of claim 1 wherein said rinsing is done by dispensing said rinse solution on a spinning wafer.

5. The method of claim 1 wherein said rinsing is done to batches of wafers.

6. The method of claim 1 wherein megasonic irradiation is applied to said wafer.

7. The method of claim 1 wherein said rinsing with said solution reduces said wafer's exposure to hydroxide ions.

8. The method of claim 1 wherein said rinsing with said solution reduces said wafer's exposure to oxygen molecules.

9. A method of rinsing a wafer comprising:
providing a wafer in a single wafer cleaning tool; and,
rinsing said wafer with a solution comprising:
H₂O; and
an acid.

10. The method of claim 9 wherein said wafer is spinning horizontally.

11. The method of claim 9 wherein said solution has a pH between 1.0-6.5.

12. The method of claim 9 wherein said solution has a pH between 3.0-6.0.

13. The method of claim 9 wherein said acid is chosen from the group comprising HCl, HNO₃, H₂SO₄, HF, acetic acid, citric acid, and CO₂.

14. The method of claim 9 wherein said acid is a gas.

15. The method of claim 9 wherein said acid is a liquid.

16. The method of claim 15 wherein said liquid acid is added to said solution by the addition of a pre-made mixture of liquid acid and water to said solution.

17. The method of claim 9 wherein gases are added to said solution by passing said solution along a hydrophobic membrane that allows gases through but not said solution.

18. The method of claim 9 wherein gases are added to said solution by a venturi apparatus.

19. The method of claim 9 wherein liquids are added to said solution by a venturi apparatus.

20. A method of rinsing a wafer comprising:
providing a wafer in a single wafer cleaning tool; and,
rinsing said wafer with a solution comprising:
H₂O; and
H₂ gas.

21. The method of claim 20 wherein said H₂ gas concentration in said solution is between 0.01 mg/l and 5 mg/l.

22. The method of claim 20 wherein said wafer is washed with hydrogen fluoride before rinsing with said solution.

23. The method of claim 22 wherein said hydrogen fluoride exposes bare silicon on said wafer's surface

24. The method of claim 22 wherein said hydrogen fluoride is used to etch said wafer's surface.

25. The method of claim 22 wherein said hydrogen fluoride is used to remove native oxide from said wafer's surface.

26. The method of claim 20 wherein said solution is followed by a spinning dry of said wafer.

27. The method of claim 20 wherein said spinning dry is assisted by the addition of isopropyl alcohol to the surface of said wafer.

28. A method of rinsing a wafer comprising:
providing a wafer in a cleaning station; and,
filtering NH₃ from the air around said cleaning station; and,
rinsing said wafer with a rinsing solution.

29. The method of claim 28 wherein said rinsing solution comprises H₂O and an acid.

30. The method of claim 28 wherein said rinsing solution comprises H₂O and H₂ gas.

31. The method of claim 28 wherein said cleaning station is a cleaning room containing baths for the batch processing of waters.

32. The method of claim 28 wherein said cleaning station is a micro-environment of a single wafer cleaning chamber.

33. The method of claim 28 wherein megasonic irradiation is applied to said wafer.

34. The method of claim 28 wherein said filtering of NH₃ from the air around said cleaning station minimizes said rinsing solution's hydroxide ion concentration.

35. A method of rinsing a wafer comprising:
providing a wafer; and,
rinsing said wafer with a rinsing solution; and,
drying said wafer after said rinsing using velocities of air exceeding 0.1 m/s.

36. The method of claim 35 wherein said rinsing solution comprises H₂O and an acid.

37. The method in claim 35 wherein said wafer's surface comprises at least partially exposed silicon.

38. The method of claim 35 wherein said wafer's surface is patterned to have trenches.

39. The method of claim 38 wherein said trenches are made of materials that have a contact angle of less than 90 degrees with water, creating a force of adhesion causing said solution to cling to said trenches.

40. The method of claim 39 wherein said force of adhesion holds said solution at the bottom of said trenches with a force greater than 1.72 bar.

41. The method of claim 35 wherein said drying using velocities of air exceeding 0.1 m/s is done to minimize said wafer's exposure to hydroxide in said rinse by decreasing drying time.

42. A solution for rinsing a wafer comprising:
H₂O;
H₂ gas; and,
an acid.

43. The solution of claim 42 wherein said solution has a pH between 1.0-6.5.

44. The solution of claim 42 wherein said solution has a pH between 3.0-6.0.

45. The solution of claim 42 wherein said acid is chosen from the group consisting of HCl, HNO₃, H₂SO₄, HF, acetic acid, citric acid, and CO₂.

46. The solution of claim 42 wherein said H₂ gas concentration in said solution is between 0.01 mg/l and 5 mg/l.
